(19) United States
(12) Patent Application Publication
(10) Pub. No.: US 2023/0186906 A1
(43) Pub. Date: Jun. 15, 2023

(54) ADVANCED SENTIMENT ANALYSIS

(71) Applicant: Calabrio, Inc., Minneapolis, MN (US)

(72) Inventors: Paul Gordon, Minneapolis, MN (US); Boris Chaplin, Medina, MN (US); Kyle Smaagard, Forest Lake, MN (US); Chris Vanciu, Isle, MN (US); Dylan Morgan, Minneapolis, MN (US); Matt Matsui, Minneapolis, MN (US); Laura Cattaneo, Rochester, MN (US); Catherine Bullock, Minneapolis, MN (US)

(21) Appl. No.: 17/549,561

(22) Filed: Dec. 13, 2021

(51) Int. Cl. G10L 15/18; G06F 16/33; G06N 3/08

(52) U.S. Cl. CPC G10L 15/1815; G06F 16/3344; G06N 3/08

(57) ABSTRACT

Systems and methods are provided for generating call sentiment associated with a call. The call includes one or more utterances. An utterance includes one or more sentences. A sentence includes one or more words. The disclosed technology iteratively generates sentiment values associated with sentences based on sentiment associated with words in the sentences, sentiment values associated with utterances based on sentence sentiment, and the call sentiment. Determining sentiment includes use of one or more a trained neural network for predicting sentiment and weighted average of sentiment values associated sentences and utterances for aggregating sentiment values. The disclosed technology generates a sentiment momentum that trends sentiment that evolves over time during the call. A speaker sentiment indicates sentiment associated with a speaker who makes utterance during the call.

Understanding context and sentiment associated with a conversation has been of public interests including consumers and businesses. For example, customer support operations routinely review content and sentiment of incoming support calls from clients to assess whether operators interacted with the clients professionally and to improve client experiences to be positive.

Reviewing and analyzing sentiment associated with conversations from calls is a time-consuming task. Automatically analyzing and determining sentiment of utterances and calls involve complex processes because there are many factors that may influence the sentiment. While sentiment associated with a sentence based on semantics and context of words within the sentence may attain a certain level of accuracy, the level of accuracy may decline when a subject area of the sentence is broader or narrower than the subject matter of a call as a whole. Issues arise in determining a sentiment of a call as a call includes more than one speaker with varying levels of sentiment that may change over the course of the call. As such, developing a technology that analyzes content of the call in a holistic manner is needed.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

Aspects of the present disclosure relate to determining sentiment associated with a call. The call can include one or more utterances by respective speakers. An utterance can include one or more sentences. The disclosure technology obtains call data (e.g., a textual transcript of a conversation having taken place during a call). A sentence sentiment determiner determines a sentiment classification for a sentence by use of artificial intelligence (e.g., a neural network for predicting a sentiment of the sentence based on a set of words in the sentence.). An utterance sentiment determiner determines an utterance sentiment for the utterance based on sentence sentiments of respective sentences in the utterance.

In aspects, the term “sentiment” may refer to a state and/or characteristics of a word, a sentence, an utterance, or a call, which can be applied to the emotional state of a participant in a dialog. A sentiment may be classified textually by one of “Negative” indicating negativity, “Neutral” indicating neutrality, “Positive” indicating positivity and/or a numerical value that represents the sentiment value. The term “sentiment momentum” may refer to a trend of sentiment in an utterance or a call, which may change over time as the utterance or call takes place. The term “sentiment saturation” may refer to how much negative, neutral, or positive language was present on a call. The sentiment saturation may also correspond to respective speakers in the call.

This Summary introduces a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for determining sentiment associated with a call in accordance with aspects of the present disclosure.

FIG. 2 illustrates an exemplar process associated with a call in accordance with aspects of the present disclosure.

FIG. 3 illustrates an exemplar process associated with generating a sentence sentiment in accordance with aspects of the present disclosure.

FIG. 4 illustrates an example process associated with generating utterance sentiment in accordance with aspects of the present disclosure.

FIG. 5 illustrates an exemplar set of rules associated with determining utterance sentiment in accordance with aspects of the present disclosure.

FIG. 6 illustrates an example process associated with generating call sentiment in accordance with aspects of the present disclosure.

FIG. 7A illustrates an exemplar set of rules associated with determining call sentiment in accordance with aspects of the present disclosure.

FIG. 7B illustrates an example of a method for determining call utterance in accordance with aspects of the present disclosure.

FIG. 8 illustrates an example data structure associated with generating call sentiment in accordance with aspects of the present disclosure.

FIG. 9 illustrates an example graph associated with sentiment momentum during a call in accordance with aspects with the present disclosure.

FIG. 10 illustrates an example of a method for determining sentiment values associated with a call in accordance with aspects of the present disclosure.

FIG. 11 illustrates an example of a method for determining sentiment values associated with a call in accordance with aspects of the present disclosure.

FIGS. 12A-C illustrate examples of a method for obtaining sentiment values associated with a call and generating an exemplary conversation in accordance with aspects of the present disclosure.

FIG. 13 illustrates a simplified block diagram of a device with which aspects of the present disclosure may be practiced in accordance with aspects of the present disclosure.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

As discussed in more detail below, the present disclosure relates to a sentiment analyzer that determines a sentiment value for a call, an utterance within the call, and a sentence within the utterance. In aspects, the sentiment analyzer may determine the sentiment value based on a transcript of a call after the call takes place and/or a stream of real-time audio data of the call as the call is in progress. According to aspects, the sentiment analyzer uses an artificial intelligence (e.g., a neural network, a probabilistic model, etc.) for predicting the sentiment values. While traditional sentiment analyzers determine sentiment of a sentence based on context and the semantics of words in the sentence, the disclosed technology determine sentiment holistically by determining sentiment of respective utterances that may include multiple sentences and, further, the sentiment of a call by aggregating the determined set of sentiment of the respective utterances. The disclosed technology further determines a sentiment momentum, which indicates a trend of a sentiment value that changes over time during the call. The disclosed technology further determines sentiment saturations associated with the call or one or more speakers during the call. Sentiment for a speaker in the call may be determined based on content of utterances made by the speaker during the call.

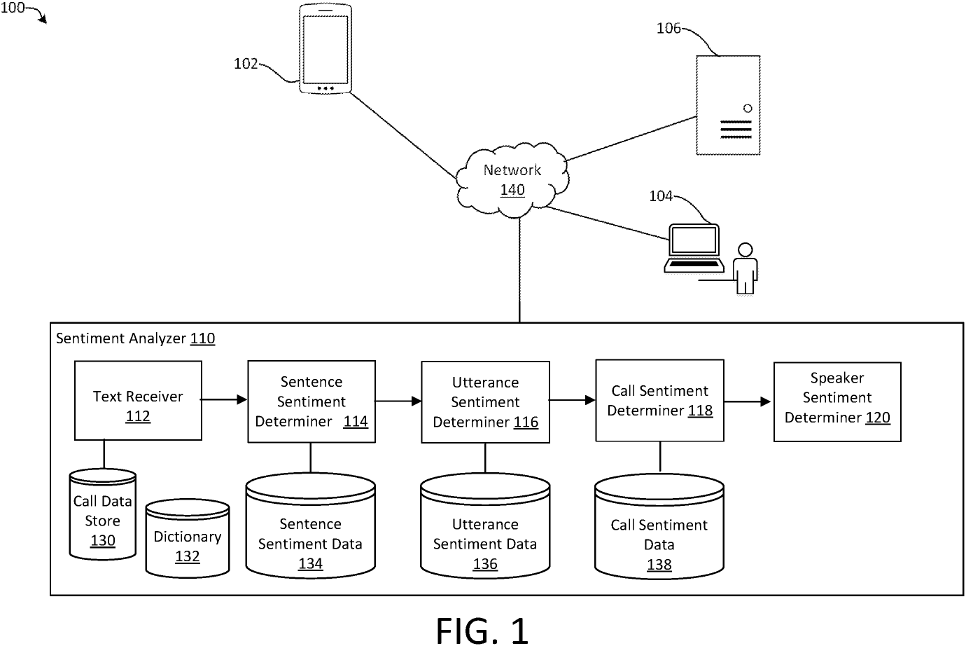

FIG. 1 illustrates an overview of an example system 100 for determining a sentiment associated with a call in accordance with the aspects of the present disclosure. The system 100 may include a client-computing device 102, a computer terminal 104, a virtual assistant server 106, and a sentiment analyzer 110, connected to one another via a network 140. In aspects, the client-computing device 102 may include a smartphone and/or a phone device where a user may participate in a call or join a conversation with another speaker. The computer terminal 104 may include an operator station where an operator of a call center may receive incoming calls from customers (i.e., a user using the client-computing device 102). The virtual assistant server 106 may process a virtual assistant for the user using the client-computing device 102 over the network 140. The user using the client-computing device 102 may join a conversation with a virtual assistant. The network 140 may be a computer communication network. Additionally or alternatively, the network 140 may include a public or private telecommunication network exchange to interconnect with ordinary phones (e.g., the phone devices).

The sentiment analyzer 110 analyzes conversations that take place during a call. The call may be a call between the user using the client-computing device 102 and the operator using the computer terminal at the call center, a call between the user and the virtual assistant being processed in the virtual assistant server 106, a call between a user and another caller, and the like. In aspects, the user and/or the operator may provide consent for the sentiment analyzer 110 to capture content (e.g., the call data) of the call.

In aspects, understanding a sentiment associated with a call is useful for evaluating and improving a quality of the operators’ interactions with customers by assessing sentiment of the operators and the customers (i.e., the callers, the users of the client-computing devices, and the like) during respective calls.

The sentiment analyzer 110 includes a text receiver 112, a sentence sentiment determiner 114, an utterance sentiment determiner 116, a call sentiment determiner 118, a speaker sentiment determiner 120, a call data store 130, a dictionary 132, sentence sentiment data store 134, utterance sentiment data 136, and call sentiment data 138.

The text receiver 112 receives call data associated with a call. In aspects, the call data may include a transcript of the utterances made during the call. The text receiver 112 may obtain the call data from one or more of the client-computing device 102, the computer terminal 104, and/or the virtual assistant server 106 over the network 140. Additionally or alternatively, the text receiver 112 may receive the call data from the network 140 as the network 140 transport the call data during the call among participants of the call. The text receiver 112 may store the call data in the call data store 130.

The call data may include a transcript of a call. In aspects, a call includes one or more utterances made by one or more speakers during the call. An utterance includes one or more sentences. A sentence includes one or more words. Additionally or alternatively, the text receiver 112 may receive audio data for determining audio-based sentiment. In aspects, audio-based sentiment includes a technology that use audio-based metrics (e.g., pitch, tone of voices of speakers, and the like) and determines sentiment. In some aspects,the text receiver 112 may receive transcripts of utterances of calls that are currently taking place. Accordingly, the disclosed technology determines audio sentiment by transcribing audio data from a call. The disclosed technology may analyze and determine sentiment associated with sentences and utterances of the latest and ongoing calls in real time. In some aspects, the disclosed technology may combine the transcription-based sentiment determination with the sentiment based on audio-based metrics.

The sentence sentiment determiner 114 determines a sentence sentiment. In aspects, a sentence sentiment represents sentiment associated with a sentence. In some aspects, the sentence sentiment determiner 114 determines a sentence sentiment using artificial intelligence (e.g., a neural network). For instance, the neural network may be trained using labeled examples of a sentence particular words corresponding with a particular sentiment (e.g., Negative, Neutral, or Positive, expressed in numerical values) as training data. The training may use the dictionary 132 as a part of training data. In some aspects, the sentence sentiment determiner 114 converts words of a sentence into one or more multi-dimensional vectors the multi-dimensional vector(s) as input to the neural network. The trained neural network may output one or more values that collectively indicate sentiment for the sentence.

Accordingly, the sentence sentiment determiner 114 may iteratively determine sentence sentiment values for one or more sentences that were uttered during the call. The sentence sentiment determiner 114 may store sentence sentiment values for sentences that occurred during the call in the sentence sentiment data 134.

The utterance sentiment determiner 116 determines utterance sentiment. In aspects, an utterance sentiment represents utterance sentiment associated with an utterance. An utterance includes one or more sentences. In aspects, the utterance sentiment determiner 116 may determine utterance sentiment by obtaining sentence sentiment of sentences in an utterance and determining an average of the sentence sentiment of the sentences.

In some aspects, the utterance sentiment determiner 116 may determine utterance sentiment based on a set of rules. For example, sentences with “Neutral” sentence sentiment may be ignored unless all sentences in the utterance are “Neutral.” If all sentences are “Neutral,” the utterance sentiment is “Neutral.” The sentiment of the majority of the sentences in the utterance may become the utterance sentiment of the utterance. If a number of sentences with “Positive” and a number of sentence with “Negative” are equal in an utterance, sentence sentiment associated with the latest (i.e., the sentence that occurs the last) in the utterance becomes the utterance sentiment of the utterance.

Accordingly, the utterance sentiment determiner 116 may iteratively determine utterance sentiment values for each utterance that occurred during the call. The utterance sentiment determiner 116 may store utterance sentiment values for sentences that occurred during the call in the utterance sentiment data 136.

The call sentiment determiner 118 determines call sentiment. In aspects, a call sentiment represents sentiment associated with a call. A call includes one or more utterances. In aspects, the call sentiment determiner 118 may determine call sentiment by obtaining determined utterance sentiments of one or more utterances made during the call and determining an average of the utterance sentiment of the utterances. In some other aspects, the call sentiment determiner 118 may determine call sentiment based on a set of rules. For example, utterance with “Neutral” utterance sentiment may be ignored unless all utterances in the call are “Neutral.” If all utterances are “Neutral,” the utterance sentiment is “Neutral.” The sentiment of the majority of the utterance in the call may become the call sentiment of the call. If a number of utterances with “Positive” and a number of utterances with “Negative” are equal during the call, utterance sentiment associated with the latest (i.e., the utterance that occurs the last) during the call becomes the call sentiment of the call. The call sentiment determiner 118 may store a call sentiment value associated with a call in the call sentiment data 138.

In aspects, the call sentiment determiner 118 determines a sentiment momentum. A sentiment momentum represents a trend (e.g., fluctuations) of sentiment throughout a call. For example, a call that starts as being “Negative” in utterances and sentences may end as being “Positive.” A sentiment momentum for the call may indicate, for example, “Strongly Improving.” The call sentiment determiner 118 may select a plurality of time points (e.g., the beginning, the ending, and one or more utterances) during a call and determine a sentiment momentum for the call. In aspects, values of the sentiment momentum may include but not limited to: Moderately Declining (Positive → Neutral, Neutral → Negative); Strongly Declining (Positive → Negative); Moderately Improving (Negative → Neutral, Neutral → Positive); Strongly Improving (Negative → Positive); and NO Change (Positive → Positive, Neutral → Neutral, Negative → Negative). In examples, the sentiment momentum may be used to classify the overall sentiment of a call. The use of sentiment momentum to classify the call sentiment allows for adjusting a classification based upon some of the factors stated above. For example, if a call starts out negative but quickly finishes on a positive note, most of the utterances would be classified as negative. A determination based upon an overall comparison of utterance sentiment may classify the call as negative due to the larger number of negatively classified utterances. However, because the call completed positively, the overall sentiment of the call may be positive since the user’s issues were ultimately addressed or solved. Use of sentiment momentum allows the systems disclosed herein to more accurately classify call sentiment, particularly when used in combination with the other sentiment determination mechanisms disclosed herein.

In some aspects, the call sentiment determiner 118 may generate a graphical representation of the sentiment momentum associated with a call by depicting a series of the sentiment momentum as slopes in a graph. For example, the graph may use a time lapse during a call along the horizontal axis and a degree of sentiment in the vertical axis. In aspects, a sentiment momentum may represent a volatility of a call by depicting the highest and lowest points of the utterance sentiment and/or sentence sentiment. In some aspects, a sentiment momentum may represent a volatility of a speaker. The graphical representation can be generated after the call or in real-time as the call is taking place. For example, a user interface may be provided which depicts the sentiment momentum in real-time as the call is taking place. The real-time depiction provides, among other benefits, a guide to the user, e.g., a call center employee, or their manager, to help steer the call towards a positive outcome for the caller as the call is in progress, thereby increasing both customer satisfaction and improving employee results. In aspects, the graphical representation may be specific to respective speakers.

The speaker sentiment determiner 120 determines speaker sentiment. Speaker sentiment represents sentiment associated with a speaker who participated in a call. There may be one or more speakers joining in a call. For example, speakers may include the user of the client-computing device 102 (e.g., a customer), the operator of the computer terminal 104 at the call center receiving calls, the virtual assistant being processed by the virtual assistant server 106, and the like. In aspects, the call data store 130 includes one or more utterances made by respective speakers during the call. In aspects, the speaker sentiment determiner 120 aggregates the sentence sentiment data, the utterance sentiment data, and the call sentiment data associated with respective speakers associated with the call.

In aspects, the sentiment analyzer 110 may transmit one or more of the sentence sentiment data 134, the utterance sentiment data 136, and/or the call sentiment data 138 as output to one or more of the client-computing device 102, the computer terminal 104, and/or the virtual assistant server 106.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

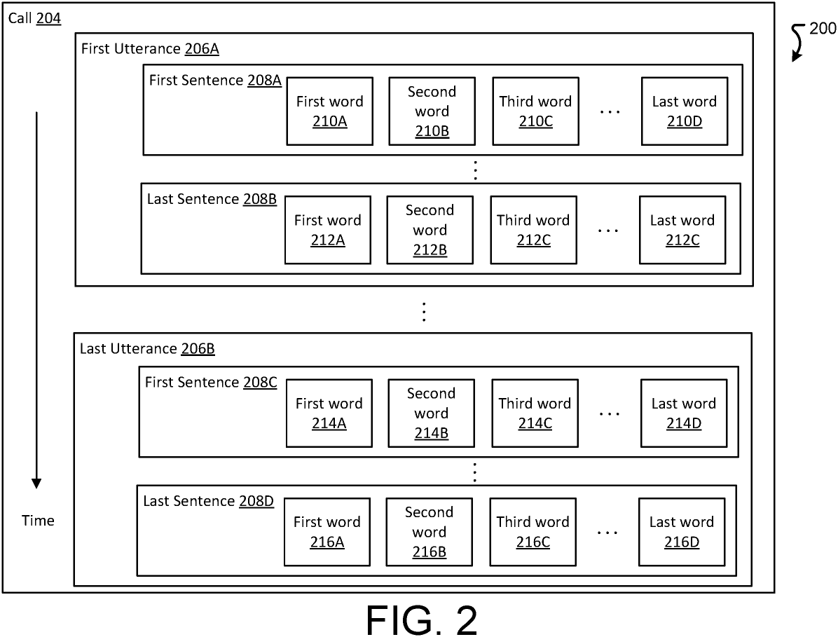

FIG. 2 illustrates an example data structure associated with a call in accordance with aspects of the present disclosure. The data structure 200 includes a call 204. In aspects, the call 204 comprises a plurality of utterances including a first utterance 206A and a last utterance 206B. Each utterance includes one or more sentences. Each sentence includes one or more words. In aspects according to FIG. 2, the first utterance 206A includes a first sentence 208A and a last sentence 208B. The first sentence 208A includes a first word 210A, a second word 210B, a third word 210C, and a last word 210D. The last sentence 208B includes a first word 212A, a second word 212B, a third word 212C, and a last word 212D. The last utterance 206B includes a first sentence 208C and a last sentence 208D. The first sentence 208C includes a first word 214A, a second word 214B, a third word 214C, and a last word 214D. The last sentence 208D includes a first word 216A, a second word 216B, a third word 216C, and a last word 216D.

In aspects, a sentiment analyzer (e.g., the sentiment analyzer 110 as shown in FIG. 1) iteratively generates a set of sentence sentiment for sentences based on words in the sentences, a set of utterance sentiment for utterances based on the set of sentence sentiment, and call sentiment for a call based on the set of utterance sentiment.

As will be appreciated, the various methods, devices, applications, features, etc., described with respect to FIG. 2 are not intended to be limited to use of the data structure 200, rather the data structure 200 is provided as an exemplary type of data structure that may be generated and/or used by the aspects disclosed herein. Accordingly, additional data structures or controller configurations may be used to practice the methods and systems herein and/or features and applications described may be excluded without departing from the methods and systems disclosed herein.

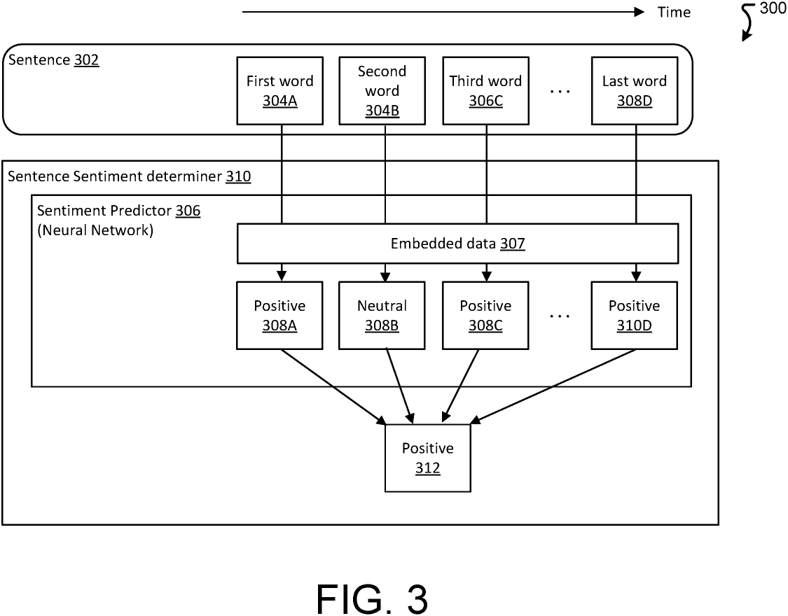

FIG. 3 illustrates an exemplary process where a sentence sentiment determiner generates a sentence sentiment based on words of a sentence in accordance with aspects of the present disclosure. The exemplary process 300 includes a sentence 302, a sentiment predictor 306, and a sentence sentiment determiner 310. The sentence 302 may be data representing one of sentences in the call data associated with the call. The sentence 302 may include a first word 304A, a second word 304B, a third word 306C, and the last word 308D.

In aspects, the sentence sentiment determiner 310 (e.g., the sentence sentiment determiner 114 as shown in FIG. 1) determines sentence sentiment for the sentence. The sentence sentiment determiner 310 includes a sentiment predictor 306. In some aspects, the sentiment predictor 306 may use artificial intelligence for predicting sentiment for the sentence. For example, the sentiment predictor 306 includes a trained neural network. In aspects, the disclosed technology includes a Transformer that has been pre-trained on a large dataset including the English language. The disclosed technology further fine-tunes the Transformer based on transcribed English. The sentiment predictor 306 may receive the words in the sentence 302 and generate a multi-dimensional embedded data 307. For example, the embedded data 307 may be a multi-dimensional vector generated to represent the sentence. Using the neural network, the sentiment predictor 306 may determine sentiment for respective words in the sentence. The neural network may further generate a classification (e.g., “Positive 312”) as sentence sentiment for the sentence 302. Alternatively or additionally, the neural network may output a value in addition to or instead of a classification. In one example, the value may range from [-1] to [1], with -1 one representing a negative sentiment, 0 a neutral sentiment, and 1 a positive sentiment. Alternatively, the neural network may generate a confidence value associated with a classification. In aspects, the output may be described as a vector length equal to the number of classification options. The vector may represent a “confidence” rating. For example, when the options are [Positive, Negative, Neutral], output may include the following: [0.8, 0.1, 0.1] representing it is highly confident that the label is positive, [0.5, 0.4, 0.1] representing a low confidence where a singular label should be positive (or likely that the true sentiment is “mixed”).

As will be appreciated, the various methods, devices, applications, features, etc., described with respect to FIG. 3 are not intended to be limited to the use of the exemplary process 300, rather the exemplary process 300 is provided to illustrate an exemplary sentence sentiment determiner that may be used by the aspects disclosed herein. Accordingly, additional processes or configurations may be used to practice the methods and systems herein and/or features and applications described may be excluded without departing from the methods and systems disclosed herein.

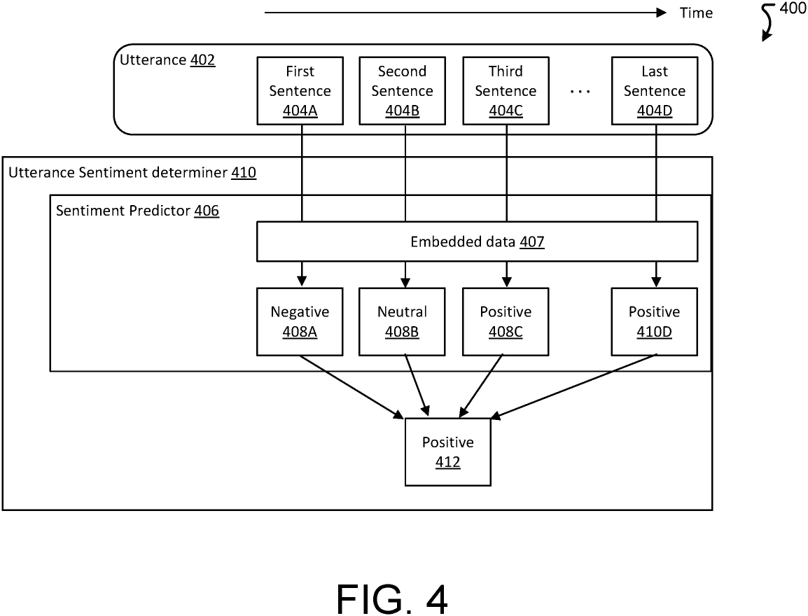

FIG. 4 illustrates an exemplary process where utterance sentiment determiner generates utterance sentiment based on sentences of an utterance in accordance with aspects of the present disclosure. The exemplary process 400 includes an utterance 402, a sentiment predictor 406, and an utterance sentiment determiner 410. The utterance 402 may be data representing one of utterances in the call data associated with the call. The utterance 402 may include a first sentence 404A, a second sentence 404B, a third sentence 406C, and the last sentence 408D of the utterance 402.

In aspects, the utterance sentiment determiner 410 (e.g., the utterance sentiment determiner 116 as shown in FIG. 1) determines utterance sentiment for the utterance. The utterance sentiment determiner 410 includes a sentiment predictor 406.

In some aspects, the sentiment predictor 406 may use artificial intelligence for predicting sentiment for the utterance. For example, the sentiment predictor 406 may be a trained neural network. The sentiment predictor 406 may receive sentences in the utterance 402 and generate a multi-dimensional embedded data 407. Using the neural network, the sentiment predictor 406 may determine sentiment for respective sentences in the utterance. The neural network may further determine a classification (e.g., “Positive 412”) as utterance sentiment associated with the utterance 402. Alternatively or additionally, the neural network may output a value in addition to or instead of a classification. In one example, the value may range from [-1] to [1], with -1 one representing a negative sentiment, 0 a neutral sentiment, and 1 a positive sentiment. Alternatively, the neural network may generate a confidence value associated with a classification.

In some other aspects, the utterance sentiment determiner 410 may determine utterance sentiment for the utterance 402 based on a set of rules. For example, sentences with “Neutral” sentence sentiment may be ignored unless all sentences in the utterance are “Neutral.” If all sentences are “Neutral,” the utterance sentiment is “Neutral.” The sentiment of the majority of the sentences in the utterance may become the utterance sentiment of the utterance. If a number of sentences with “Positive” and a number of sentence with “Negative” are equal in an utterance, sentence sentiment associated with the latest (i.e., the sentence that occurs the last) in the utterance becomes the utterance sentiment of the utterance.

As will be appreciated, the various methods, devices, applications, features, etc., described with respect to FIG. 4 are not intended to limit use of the exemplary process 400. Rather, the exemplary process 400 including the utterance sentiment determiner 410 is provided as an example of generating utterance sentiment that may be used by the aspects disclosed herein. Accordingly, additional and/or alternative processes and configurations may be used to practice the methods and systems herein and/or features and applications described may be excluded without departing from the methods and systems disclosed herein.

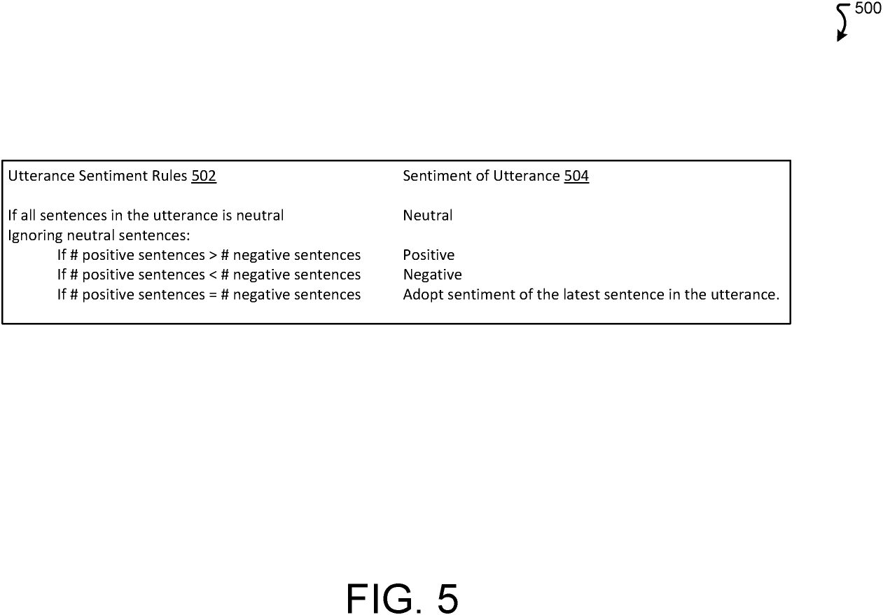

FIG. 5 illustrates an exemplary set of rules associated with determining utterance sentiment in accordance with aspects of the present disclosure. In aspects, the set of rules 500 includes the utterance sentiment rules 502 and resulting utterance sentiment 504 as follows. If all sentences in the utterance have sentence sentiment “Neutral,” utterance sentiment is “Neutral.” After ignoring sentences that are “Neutral,” the rule instructs counting numbers of sentences with respective sentence sentiment of “Positive” or “Negative.” If a number of sentences with “Positive” is greater than a number of sentences with “Negative,” then, utterance sentiment is “Positive.” If a number of sentences with “Positive” is less than a number of sentences with “Negative,” then, utterance sentiment is “Negative.” If a number of sentences with “Positive” is the same as a number of sentences with “Negative,” then, sentence sentiment associated with the latest sentence in the utterance becomes utterance sentiment. If either positive sentences or negative sentences exist in the utterance, the utterance sentiment excludes being “Neutral.” While FIG. 5 depicts exemplary rules, one of skill in the art will appreciate that other rules may be used with the aspects disclosed herein without departing from the scope of this disclosure.

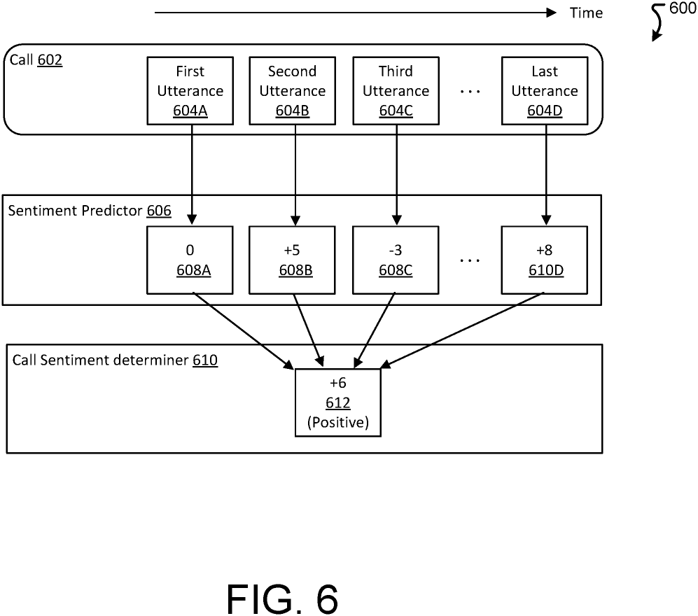

FIG. 6 illustrates an exemplary process associated with generating call sentiment in accordance with aspects of the present disclosure. The process 600 includes a call 602, a sentiment predictor 606, and a call sentiment determiner 610. The call 602, which may be data representing call data associated with a call, may include a first utterance 604A, a second utterance 604B, a third utterance 604C, and the last utterance 604D of the call 602.

The sentiment predictor 606 receives the call 602 as input data and predicts utterance sentiment for respective utterances associated with the call 602. In aspects, utterance sentiment may be expressed by terms including “Negative,” “Neutral,” “Positive,” and the like. In some other aspects, utterance sentiment may be expressed by one or more numerical values with varying degrees of negativity and positivity in sentiment. For example, utterance sentiment of a value -3 (608C) associated with the third utterance 604C may represent a “Negative” sentiment at a third degree from neutral. A value zero 608A associated with the first utterance 604A may represent “Neutral.” An utterance sentiment value of +5 (608B) associated with the second utterance 604B and +8 (610D) associated with the last utterance 604D both represent respective degrees of “Positive” sentiment. The value +8 (610D) associated with the last utterance 604D indicates a higher degree of “Positive” sentiment than +5 (608B) associated with the second utterance 604B.

The call sentiment determiner 610 determines call sentiment based on the respective utterance sentiment values. In aspects, the call sentiment determiner 610 may determine call sentiment by using a neural network, similar to the method as detailed above for determining utterance sentiment based on sentence sentiment.

In some other aspects, the call sentiment determiner 610 may determine call sentiment by determining an average sentiment value of the utterance sentiment values associated with a predetermined set of utterances in the call. The call sentiment determiner 610 may determine an overall call sentiment value based on the average value. Additionally or alternatively, the call sentiment determiner 610 may determine a weighted average of the utterance sentiment values by weighing more on utterances that are toward the end of the call. In aspects, utterances toward the end of a call may influence the overall sentiment of the call more than earlier utterances during the call.

In the exemplar data as shown in FIG. 6, the call sentiment determiner 610 determines a call sentiment value of +6 (612), which represents “Positive” sentiment at six degrees higher than “Neutral.”

As will be appreciated, the various methods, devices, applications, features, etc., described with respect to FIG. 6 are not intended to limit use of the exemplary process 600 to being performed by the particular applications and features described. Rather, the exemplary process 600 including the call sentiment determiner 610 is provided as an example of generating call sentiment that may be used by the aspects disclosed herein. Accordingly, additional and/or alternative processes and configurations may be used to practice the methods and systems disclosed herein.

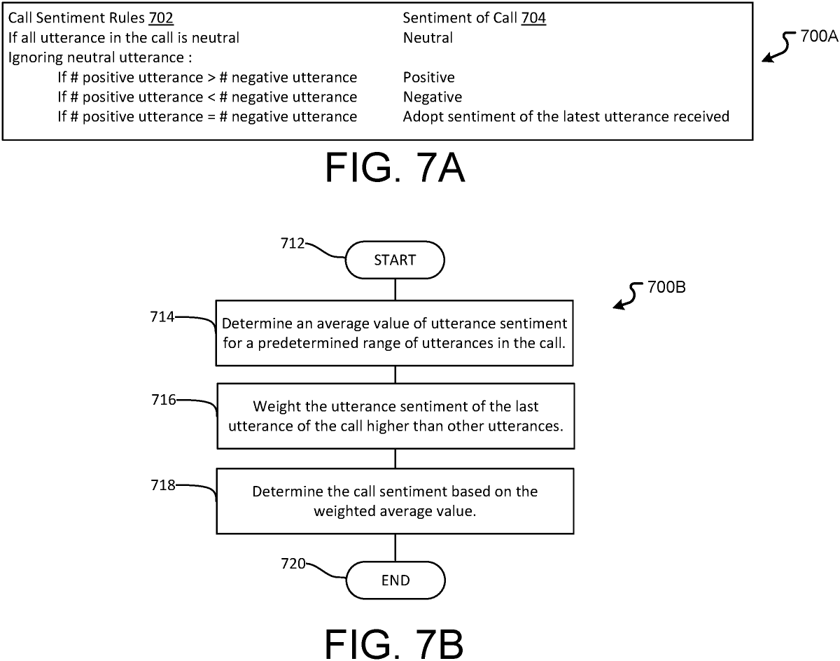

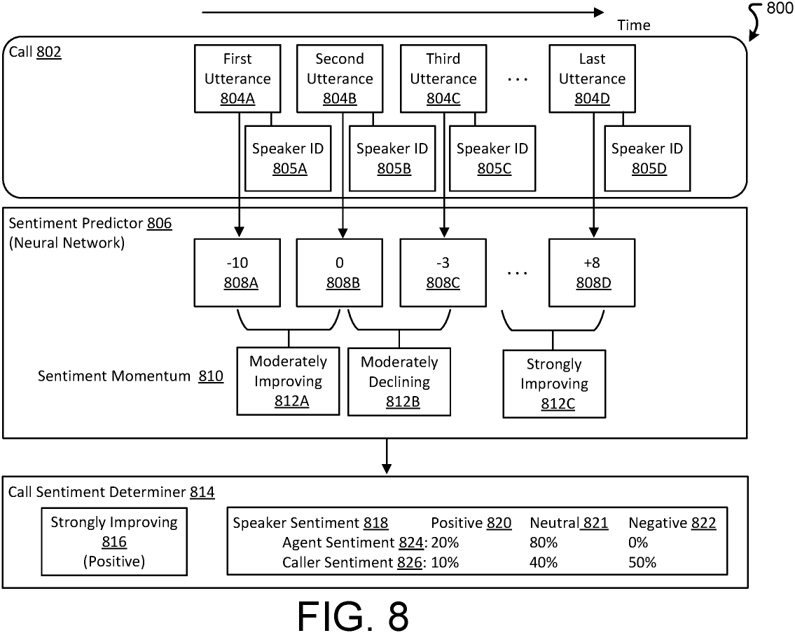

FIG. 7A illustrates an exemplary set of rules associated with determining call sentiment in accordance with aspects of the present disclosure. In aspects, the set of rules 700A includes the call sentiment rules 702 and resulting call sentiment 704 as follows. If all utterances in the call have utterance sentiment “Neutral,” call sentiment is “Neutral.” After ignoring utterances that are “Neutral,” the rule instructs counting numbers of utterances with respective utterance sentiment of “Positive” or “Negative.” If a number of utterances with “Positive” is greater than a number of utterances with “Negative,” then, call sentiment is “Positive.” If a number of utterances with “Positive” is less than a number of utterances with “Negative,” then, call sentiment is “Negative.” If a number of utterances with “Positive” is the same as a number of utterances with “Negative,” then, call sentiment associated with the latest utterances in the call data becomes call sentiment. If either positive utterances or negative utterances exist in the call, the call sentiment excludes being “Neutral.” While FIG. 7A depicts exemplary rules, one of skill in the art will appreciate that other rules may be used with the aspects disclosed herein without departing from the scope of this disclosure.

FIG. 7B illustrates an example method 700B for determining call sentiment in accordance with aspects of the present disclosure. A general order of the operations for the method 700B is shown in FIG. 7B. Generally, the method 700B begins with start operation 712 and end with end operation 720. The method 700B may include more or fewer steps or may arrange the order of the steps differently than those shown in FIG. 7B. The method 700B can be executed as a set of computer-executable instructions executed by a cloud system and encoded or stored on a computer readable medium. Further, the method 700B can be performed by gates or circuits associated with a processor, an ASIC, an FPGA, a SOC or other hardware device. Hereinafter, the method 700B shall be explained with reference to the systems, components, devices, modules, software, data structures, data characteristic representations, signaling diagrams, methods, etc., described in conjunction with FIGS. 1, 2, 3, 4, 5, 6, 7A, 8, 9, and 10.

Following start operation 712, the method 700B begins with determine operation 714, which determines an average value of utterance sentiment associated with a set of utterances associated with a call. In aspects, the set of utterances may include all or a part of a series of utterances during the call. As detailed above, the utterance sentiment determiner (e.g., the utterance sentiment determiner 116 as shown in FIG. 1) determines utterance sentiment values associated with utterances of the call. In aspects, the one or more utterances that are part of the set utterances may depend on various factors including but not limited to a number of utterances during the call, the person associated with the utterance, subject matter associated with the utterances, or any other factors. In aspects, the determine operation 714 may select one or more utterances with utterance sentiment values that are within a predetermined variance. The utterance sentiment determiner then determines an average value of utterance sentiment values. In other aspects, the determine operation 714 may determine average values of utterance sentiments separately according to speakers of the call.

Weight operation 716 weights the utterance sentiment of one or more particular utterances of the call higher than the utterance sentiment of other utterances. In aspects, the weight operation 714 may weigh more on the last and/or a predefined number of utterances toward the latest utterance of the call. In some aspects, the weight operation 714 may weigh utterance sentiment of a particular speaker (e.g., a customer caller in a support call) more than other speakers participating in the call. In yet some other aspects, the weight operation 714 may weigh a peak value (positive and/or negative) of utterance sentiment of an utterance more than other values of utterance sentiment.

Determine operation 718 determines the call sentiment based on the weighted average sentiment values. In aspects, the call sentiment represents an overall sentiment associated with the call. When the call is currently in progress, the call sentiment may represent sentiment of the call thus far. That is, the call sentiment may not necessarily reflect (although may be weighted) the overall current sentiment of the ongoing call but rather, the current sentiment of the call in real-time. Additionally or alternatively, the determine operation 718 may determine a set of a of sentiment values to represent the call sentiment: one that is the weighted average of sentiment of the call and additional call sentiment values associated with respective speakers of the call. The method 700B ends with end operation 720. Additionally or alternatively, the determine operation 718 may determine sentiment at various stages during the call that has taken place. Based on the sentiment at various stages, the determine operation 718 may generate a summation graph (e.g., a graphical representation that summarizes sentiment) that depicts how sentiment changes over stages (and/or time) during the call.

As should be appreciated, operations 712-720 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

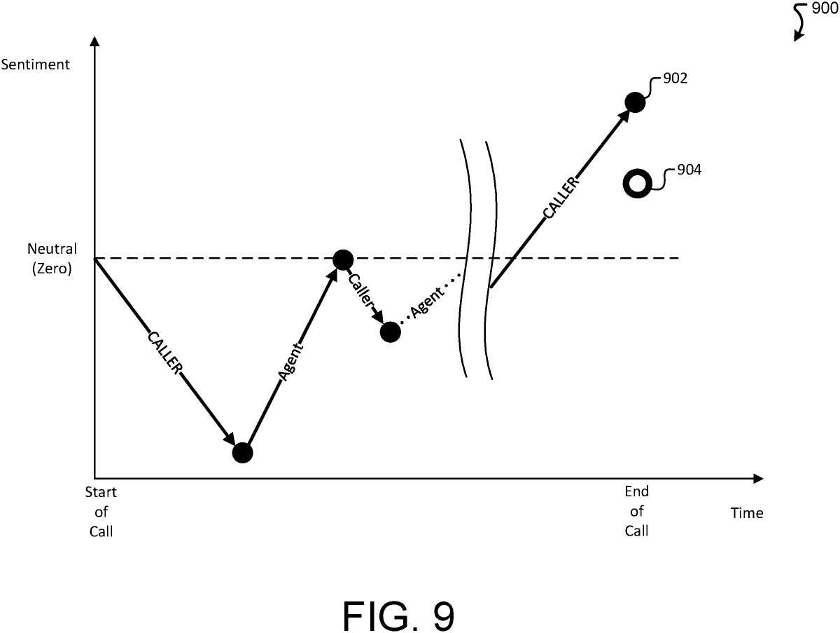

FIG. 8 schematically illustrates an exemplary process associated with generating call sentiment in accordance with aspects of the present disclosure. The exemplary process 800 includes a call 802, a sentiment predictor 806, and a call sentiment determiner 814. The call 802 may be call data that represent content of the call. The call 802 may include a first utterance 804A, a second utterance 804B, a third utterance 804C, and the last utterance 804D of the call 602. In aspects, respective utterances may be associated with a speaker identification (ID). For instance the first utterance 804A may correspond to a speaker ID 805A. The speaker identification 805A may indicate “Caller” as the speaker who made the first utterance 804A. The second utterance 804B may correspond to a speaker ID 805B. The speaker ID 805B may indicate “Agent” as the speaker who uttered the second utterance 804B. Similarly, the third utterance 804C may correspond to a speaker ID 805C. The last utterance 804D may correspond to a speaker ID 805D.

The sentiment predictor 806 may predict sentiment momentum of the call based on changes in utterance sentiment values across utterances during the call. In aspects, an utterance value -10 (808A) represents utterance sentiment (i.e., a tenth degree of “Negative” from neutral) of the first utterance 804A. An utterance value 0 (808B) represents utterance sentiment (i.e., “Neutral”) of the second utterance 804B. An utterance value -3 (808C) represents utterance sentiment (i.e., a third degree of “Negative” from neutral) of the third utterance 804C. An utterance value +8 (808D) represents utterance sentiment (i.e., an eighth degree of “Positive” from neutral) of the last utterance 804D.

The sentiment momentum 810 represents a trend or fluctuations of sentiment throughout a call. For instance, a sentiment momentum 810 at the end of the second utterance is “Moderate Improving” (812A) based on the change of utterance sentiment from a value -10 (808A) (i.e., a tenth degree of “Negative” from neutral) to a value 0 (808B) (i.e., “Neutral”). Similarly, a next sentiment momentum at the end of the third utterance 804C may be “Moderately Declining” (812B) based on a decline from “Neutral” to “Negative.” The last sentiment momentum of the call according to this example may be “Strongly Improving” (812C). In aspects, values of the sentiment momentum may include but not limited to: “Moderately Declining” (from “Positive” to “Neutral,” from “Neutral” to “Negative”); “Strongly Declining” (from “Positive” to “Negative”); “Moderately Improving” (from “Negative” to “Neutral,” from “Neutral” to “Positive”); “Strongly Improving” (from “Negative” to “Positive”); and “NO Change” (from “Positive” to “Positive,” from “Neutral” to “Neutral,” from “Negative” to “Negative”).

In aspects, the call sentiment determiner 814 determines call sentiment and speaker sentiment (i.e., collectively a sentiment saturation) for the call 802. For example, two very different calls (one very “boring” with 95% neutral languages and another very heated/escalated call with 40% positive+ 40% negative) both may result as Neutral leaving the users missing the key insights. In some other aspects, as most agents may be trained to remain neutral or positive during a call, most customers are interested in caller sentiment, which is important to isolate the sentiment by each speaker rather than at a call level. The call sentiment is shown as “Strongly Improving” 816 (Positive). In some aspects, the call sentiment determiner 814 determines call sentiment by weighing utterance sentiment of the latest (i.e., the last) utterance that has taken place during the call. For example, the utterance sentiment value of +8 (808D) may be weighed more than negative utterance sentiment in utterances that took place earlier during the call. Additionally or alternatively, the call sentiment determiner 814 may determine sentiment momentum holistically at a call level. For example, the first five minutes of a call may have started out poorly (i.e., negatively) but the problem was resolved, the agent did well, and the customer was happy at the end of the call, the call would represent a positive sentiment momentum at the call level. In aspects, aggregation of sentiment takes place at one or more points during the call. The aggregation may determine the “start state” and the “end state,” which may be an aggregation of utterances based on time or relative proportion of the call (i.e., the first 20% and the last 20% of the call). As detailed below, the sentiment predictor 806 may predict utterance sentiment while identifying speakers associated with respective utterances.

The speaker sentiment 818 represents sentiment associated with a speaker that participated in the call. For example, the call 802 includes two speakers: an agent (e.g., the operator using the computer terminal 104 as shown in FIG. 1) and a caller (e.g., the customer or the user of the client-computing device 102 as shown in FIG. 1). The speaker sentiment 818 provides a ratio of distinct types of sentiment associated with a speaker during the call: “Positive” (820), “Neutral” (821), and “Negative” (822).

Additionally and/or alternatively, the speaker sentiment 818 may include individual speaker sentiment values associated with the individual speakers participating in the call 802. In aspects, the sentiment predictor 806 can predict call sentiment and sentiment momentum separately for the individual speakers on the call 802 by selectively receiving utterances that correspond to specific speakers based upon the speaker ID associated with the utterances.

Accordingly, the speaker sentiment 818 includes agent sentiment 824 and caller sentiment 826. The agent sentiment 824 indicates “Positive” sentiment of 20%, “Neutral” sentiment of 80%, and “Negative” sentiment of 0 % (zero). The caller sentiment 826 indicates “Positive” sentiment of 10%, “Neutral” sentiment of 40%, and “Negative” sentiment of 50%. That is, the example appears to indicate that the caller indicated “Negative” sentiment about a half the time during the call while the agent was mostly “Neutral” if not “Positive” throughout the all.

In aspects, the sentiment predictor 806 may predict utterance sentiment while identifying speakers associated with respective utterances. For example, the caller may have spoken the first utterance 804A. Subsequently, the caller and the agent may have alternated the rest of utterances (e.g., the agent making the second utterance 804B, the caller making the third utterance 804C, and the like). In the example as shown in FIG. 8, the sentiment momentum for the call indicates “Strongly Improving” 816, while the caller indicated rather strong negative sentiment in its speaker sentiment. An analysis may show that the sentiment momentum for the call shows the positive thrust of “Strongly Improving” because the call ended with very positive sentiment in the last utterance 804D with relatively strong “Positive” sentiment value of +8 (808D).

As such, the presented disclosure enables analyzing utterances made during a call in a holistic manner by determining call sentiment based on sentiment of the underlying data structure (i.e., utterances, sentences, and words). Furthermore, the disclosed technology tracks the sentiment momentum throughout the call while weigh specific parts of the call (e.g., utterances toward the end of the call) more than others. Determining speaker sentiment further enables separately analyzing how respective speakers of the call expressed sentiment during the call. For example, call center businesses may aim at the agent sentiment to be neutral to slightly positive to interact with callers (e.g., customers) in a professional manner.

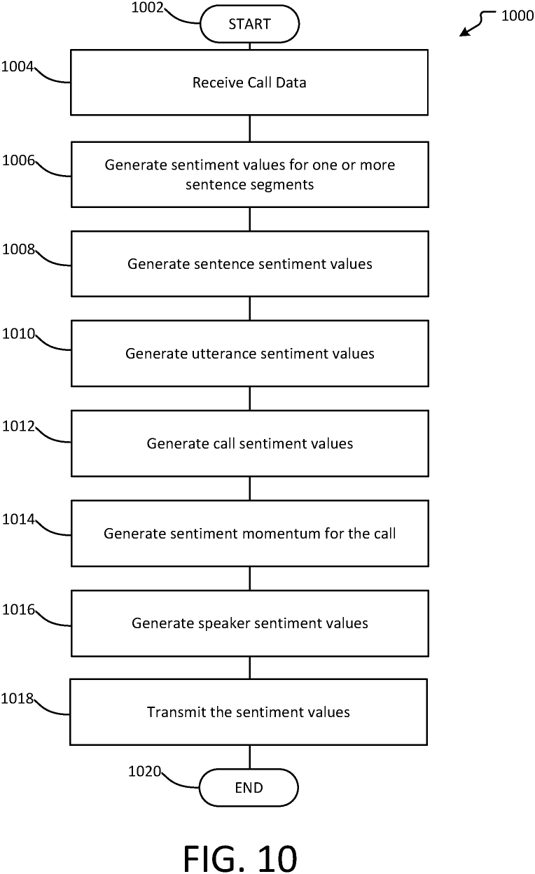

FIG. 9 illustrates an example of a graphical representation of sentiment associated with a call and its utterances according to aspects of the present disclosure. The graph 900 depicts how sentiment changes over a series of utterances (e.g., over time) during the call. In aspects, each line segment of the graph represent changes that took place during an utterance. For instance, in the depicted example the call starts with neutral sentiment. The first utterance by the Caller ends with negative utterance sentiment. The second utterance by the Agent ends with neutral sentiment (e.g., the changes in utterance sentiments as shown in FIG. 8). Slopes of the line segment may represent a series of sentiment momentum during the utterance. The sentiment value 902 indicates an utterance sentiment of the last utterance of the call. The sentiment value 904 indicates a call sentiment that represents the overall sentiment of the call. While the exemplary graph tracks sentiment of both parties to the conversation, alternatively, individual graphs may be generated to depict the sentiment of the individual participants. Further, the graph 900 may be generated and updated in real-time, thereby allowing the Agent or a manager to track the sentiment of the call while the call is in progress.

In aspects, respective line segments of the graph may indicate speakers who made respective utterance. For example, the graph 900 indicates that the Caller made the first utterance. The Agent made the second utterance, and the like.

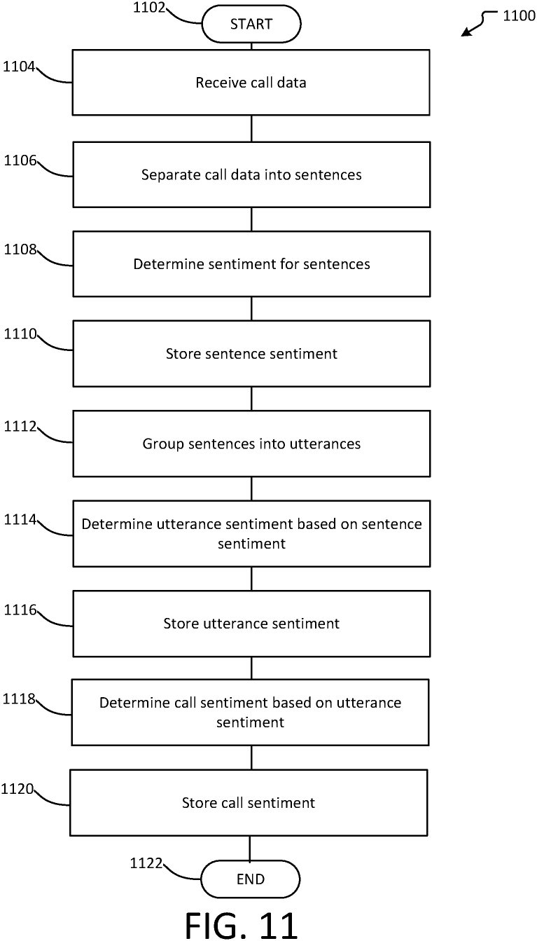

FIG. 10 illustrates an example of a method for determining sentiment values associated with a call in accordance with aspects of the present disclosure. A general order of the operations for the method 1000 is shown in FIG. 10. Generally, the method 1000 begins with start operation 1002 and ends with end operation 1020. The method 1000 may include more or fewer steps or may arrange the order of the steps differently than those shown in FIG. 10. The method 1000 can be executed as a set of computer-executable instructions executed by a computer system and encoded or stored on a computer readable medium. Further, the method 1000 can be performed by gates or circuits associated with a processor, an ASIC, an FPGA, a SOC or other hardware device. Hereinafter, the method 1000 shall be explained with reference to the systems, components, devices, modules, software, data structures, data characteristic representations, signaling diagrams, methods, etc., described in conjunction with FIGS. 1, 2, 3 4, 5, 6, 7A-B, 8, 9, 11, 12, and 13.

Following start operation 1002, the method 1000 begins with receive operation 1004, which receives call data. In aspects, the call data may include a transcript of utterances made during a call. In some instances, the call data may be received from a transcription database, which stores transcriptions of completed calls. In other instances, the call data may be received in real-time while the call is in progress. In such instances, the receive operation 1004 may include additional processing, such as performing a speech-to-text translation of the call audio.

Generate word-by-word sentiment operation 1006 generates word-by-word sentiment embeddings (i.e., word sentiment). In aspects, the generate word-by-word sentiment operation 1006 may compare embeddings of words of a sentence to a stored dictionary associating sentiment values with words and/or a trained prediction model to determine a word sentiment embeddings. The generate operation 906 may iteratively determiner word-by-word sentiment embeddings associated with words in the call.

Generate sentence sentiment operation 1008 generates sentence sentiment values. A sentence sentiment value represents sentiment associated with a sentence in an utterance made during a call. In aspects, the generate sentence sentiment operation 1008 may use an artificial intelligence (e.g., a neural network) with a trained prediction model to determine the sentence sentiment value based on words and contexts associated with respective sentences. For instance, the generate sentence sentiment operation 1008 may generate multi-dimensional vectorized data associated with one or more words in the sentence. The artificial intelligence processing (e.g., a neural network model, a probability model, etc.) may use the multi-dimensional vectorized data to predict a sentiment value by processing the multi-dimensional vectorized data through a plurality of layers of the neural network, for example. The model may be trained using training data that includes true examples of a pair of a sentence and a sentence sentiment.

Generate utterance sentiment operation 1010 generates utterance sentiment values. An utterance sentiment value represents sentiment associated with an utterance made during a call. In aspects, the generate utterance sentiment operation 1010 may use artificial intelligence (e.g., a neural network) with a trained prediction model to determine the utterance sentiment value based on sentences and contexts associated with respective utterances. In aspects, the trained prediction model may be based on a neural network, a Transformer model, a probability model, and/or other machine learning models. One of skill in the art will appreciate that any type of neural network or artificial intelligence process or agent may be employed with the aspects disclosed herein. Additionally or alternatively the generate utterance sentiment operation 1010 may use a set of predefined rules to aggregate sentence utterance values associated with sentences in the respective utterances. In some aspects, the generate utterance sentiment operation 1010 determine weighted average of sentence sentiment by weighing sentiment associated with sentences in a particular part of the utterance (e.g., sentence toward the end of the utterance) more than others in aggregating the sentence sentiment values (e.g., the set of rules 500 as shown in FIG. 5).

Generate call sentiment operation 1012 generates a call sentiment value. A call sentiment value represents sentiment associated with a call. In aspects, the generate operation 1012 aggregates utterance sentiment values associated with respective utterances made during the call. The generate call sentiment operation 1012 may use a set of rules (e.g., the set of rules 700A as shown in FIG. 7A) to aggregate utterance sentiment values as detailed above.

Generate sentiment momentum operation 1014 generates a sentiment momentum for the call. In aspects, a sentiment momentum indicates a trend of a sentiment value (e.g., utterance sentiment of utterances made by respective speakers) that changes over time during the call. For example, sentiment of a customer who is making a call to a customer support center to file a complaint may start the call with an utterance indicating negative sentiment. As the agent interactively hears the complaint in a professional manner with a neutral or slightly positive sentiment, the sentiment of the customer may improve to neutral or even positive toward the end of the call. The call as a whole may be indicating a sentiment momentum of “Strongly Improving.”

Generate operation 1016 generates speaker sentiment values. In aspects, the generate operation 916 determines a ratio of sentiment “Positive,” “Neutral,” and “Negative” based on utterance sentiment associated with utterances made by the speaker (e.g., the speaker sentiment 818 as shown in FIG. 8). In aspects, the speaker sentiment determiner 120 aggregates the sentence sentiment data, the utterance sentiment data, and the call sentiment data associated with respective speakers associated with the call.

Transmit operation 1018 transmits results of the sentiment analysis (e.g., call sentiment, sentiment momentum, speaker sentiment) to one or more client devices and servers as output for rendering the results. The method 1000 ends with end operation 1020.

As should be appreciated, operations 1002-1020 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

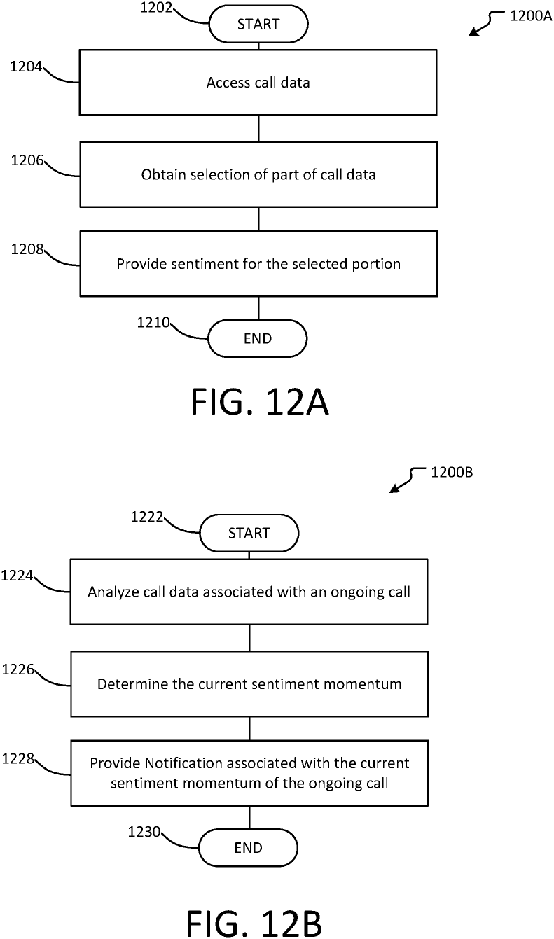

FIG. 11 illustrates an example of a method 1100 for determining sentiment values associated with a call in accordance with aspects of the present disclosure. A general order of the operations for the method 1100 is shown in FIG. 11. Generally, the method 1100 begins with start operation 1102 and ends with end operation 1022. The method 1100 may include more or fewer steps or may arrange the order of the steps differently than those shown in FIG. 11. The method 1100 can be executed as a set of computer-executable instructions executed by a computer system and encoded or stored on a computer readable medium. Further, the method 1100 can be performed by gates or circuits associated with a processor, an ASIC, an FPGA, a SOC or other hardware device. Hereinafter, the method 1100 shall be explained with reference to the systems, components, devices, modules, software, data structures, data characteristic representations, signaling diagrams, methods, etc., described in conjunction with FIGS. 1, 2, 3 4, 5, 6, 7A-B, 8, 9, 10, 12, and 13.

Following start operation 1102, the method 1100 begins with receive operation 1104, which receives call data. In aspects, the call data may include a transcript of utterances made during a call. The receive operation 1104 may receive the call data from one or more of the client computing device, one or more computer terminals, and a server including a virtual assistant server. In other instances, the call data may be received in real-time while the call is in progress. In such instances, the receive operation 1004 may include additional processing, such as performing a speech-to-text translation of the call audio. One of skill in the art will appreciate that the call data may be in any form capable of being processed or analyzed, e.g., audio files, text transcripts, and the like.

Separate operation 1106 separates the call data into one or more sentences. In aspects, the call data include one or more utterances. An utterance may include one or more sentences. A sentence may include one or more words. In aspects, the separate operation 1106 may determine a speaker for sentence based on the call data with the transcript. In aspects, the separate operation 1106 uses one or more of, but not limited to, the following characters as sentence demarcations to separate sentences: periods, exclamation points, and question marks.

Determine operation 1108 determines sentiment for sentences. In aspects, the determination operation 1108 may use words dictionary that includes semantics of words to determine a context and sentiment for the sentences.

Store operation 1110 stores the determined sentiment for sentences. In aspects, the store operation 1110 stores sentence sentiments by indexing based on a sequence of sentences associated with an utterance. In some other aspects, the store operation may store the sentence sentiment indexed by the sentences. For example, the sentences may be indexed based upon different factors such as sentence sentiment, subject matter, speaker identifier, call type, department, etc.

Group operation 1112 groups the sentences into utterances. In aspects, the group operation 1112 may group the sentences into utterances by associating respective sentences with an utterance that includes the sentences. For example, the call transitioning from a first speaker to a second may be an indicator that the sentences before the transition should be grouped in to an utterance. Additionally or alternatively, a lengthy pause (i.e., a pause that is longer than a predetermined time threshold) may indicate a break in utterance. A user operation of putting the call on hold during a phone call may also indicate a break in utterance.

Determine operation 1114 determines utterance sentiment based on sentence sentiment. In aspects, the determine operation 1114 may aggregate sentence sentiment associated with sentences in an utterance by determining an average of the sentence sentiment values. In some aspects, the averages may be weighted based on a position of a sentence in the utterance. For instance, the determine operation 1114 may weight sentence sentiment of sentences that are toward the end of an utterance.

Store operation 1116 stores the determined utterance sentiment associated with utterances in the call data in a sentiment analyzer (e.g., the utterance sentiment data 136 as shown in FIG. 1). In aspects, the store operation 1116 stores the utterance sentiment based on indexing by a sequence of utterances during a call. Additionally and/or alternatively, the store operation 1116 stores the utterance sentiment based on indexing by types of utterance sentiment. While the method 1100 describes storing the sentiment for individual sentences and utterances, one of skill in the art will appreciate that the sentiment does not necessarily need to be stored at these different levels of granularity. However, by storing the sentiment for the individual sentences, utterances, and calls separately, aspects disclosed herein are able to recall and display sentiment values at different levels of granularity during or after the call.

Determine operation 1118 determines call sentiment based on utterance sentiment. In aspects, a call sentiment value represents sentiment associated with a call. In aspects, the determine operation 1118 may aggregate utterance sentiment values associated with respective utterances made during the call. The determine operation 1118 may use a set of rules (e.g., the set of rules 700A as shown in FIG. 7A) to aggregate utterance sentiment values as detailed above.

Store operation 1120 stores the determined call sentiment in a call sentiment store (e.g., the call sentiment data 138 as shown in FIG. 1). The store operation 1120 may store the call sentiment based on indexing by types of calls (e.g., a customer support call, an internal meeting, and the like) and/or types of call sentiments. The method 1100 ends with end operation 1122.

As should be appreciated, operations 1102-1022 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

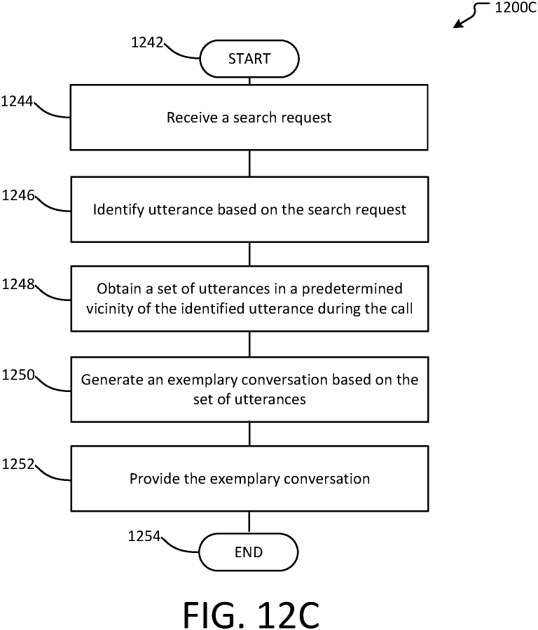

FIG. 12A illustrates an example method for obtaining a selection of a portion of call data in accordance with the present disclosure. The method 1200A starts with start operation 1202, followed by an access operation 1204. The access operation 1214 access call data. In aspects, the call data may be received from one or more of client computing devices, a network, a computer terminal used for participating in calls, and a server (e.g., a virtual assistant server).

Obtain operation 1206 obtains a selection of part of call data. In aspects, the part of call data may include a predefined portion of a call (e.g., beginning, middle and/or toward the end of the call). In some aspects, the portion of the call may be specified by a particular user. In aspects, the portion of the call may be obtained based upon a query for specific information associated with one or more parts of the call. The query may include one or more parameters, such as, agent type, sentiment value, subject matter, and the like. In doing so, the method 1200 provides a way for agents or managers to query call data in order to identify specific portions of calls based, for example, on call sentiment or changes in call sentiment.

Provide operation 1208 provides sentiment for selection portion of the call to a requesting device. In aspects, the sentiment may be one or more utterance sentiment associated with a selected set of utterances of the call. In some other aspects, the provide operation 1208 may transmit call sentiment associated with the call. The method 1200A ends with end operation 1210.

As should be appreciated, operations 1202-1210 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 12B illustrates an example method for providing a notification associated with the current sentiment momentum of an ongoing call in accordance with the present disclosure. The method 1200B starts with start operation 1222, followed by an analyze operation 1224.

The analyze operation 1224 analyzes call data associated with an ongoing call. In aspects, the call data may include data associated with more than one ongoing calls. The analyze operation 1224 may analyze the call data by receiving a request for analyzing the call data by specifying a particular call to analyze.

Determine operation 1226 determines the current sentiment momentum associated with the ongoing call. In aspects, the current sentiment momentum may be based on a sentiment momentum associated with the latest (i.e., the current) utterance being held in the ongoing call. In some other aspects, the current sentiment momentum may be based on the latest utterance that has completed during the ongoing call. In some aspects, the determine operation determines a speaker associated with the utterance that is currently being analyzed to determine the current sentiment momentum. In some other aspects, the determine operation may determine the current sentiment momentum by aggregating (e.g., a weighted average) of values of sentiment momentum associated with utterances held thus far during the ongoing call.

Provide operation 1228 provide a notification associated with the current sentiment momentum of the ongoing call. In aspects, the provide operation 1228 transmits the notification to one or more of the client computing devices, such as a computing terminal used by an agent of a support call center, a manager, and/or a virtual assistant. In certain aspects, the notification may be provided in response to certain triggers, such as detection of a negative sentiment, detecting a negative sentiment momentum, a change in sentiment momentum in general, or any other type of sentiment change that the agent and/or manager is interested in. As such, the method 1200B may be customizable by different users to provide notifications based upon conditions or factors of interest to a particular user. The method 1200B ends with end operation 1230.

As should be appreciated, operations 1222-1230 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 12C illustrates an example method for generating and providing an exemplary conversation in accordance with aspects of the present disclosure. The method 1200C starts with start operation 1242 and ends with end operation 1254. Following the start operation 1242, receive operation 1244 receives a search request. In aspects, the receive operation 1244 receives the request from one or more of users of client computing devices, such as computing devices associated with a call center agent or manager, and/or a virtual assistant being served by a virtual assistant server.

In aspects, the search request may include search parameters that specify one or more types of sentiment as a condition of the search. For example, the search request may request a search for utterances with positive utterance sentiment to generate an exemplary conversation. In aspects, the search parameters may also specify a level of granularity. For example, the search parameters may specify sentiment values on a sentence, utterance, or call level.

Identify operation 1246 identifies utterances based on the search request. In aspects, the identify operation searches for utterances using an indexed storage of utterance sentiment. In some other aspects, the identify operation 1246 may generate a set of identifiers of utterances.

Obtain operation 1246 obtains a set of utterances based on the identified utterance. In aspects, the obtain operation 1246 may obtain the set of utterances from the call data by specifying one or more utterances that precedes and/or proceeds the identified utterance during a call.

Generate operation 1250 generates an exemplary conversation based on the set of utterances. In aspects, the generate operation 1250 may aggregate the set of sentences or utterances in series as a conversation. In some other aspects, the generate operation 1250 generates the exemplary conversation without modifying entities expressed in the utterances. Finally, provide operation 1252 provides the exemplary conversation. In aspects, the provide operation 1252 transmit the exemplary conversation to the device that provided the search request.

As should be appreciated, operations 1242-1254 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

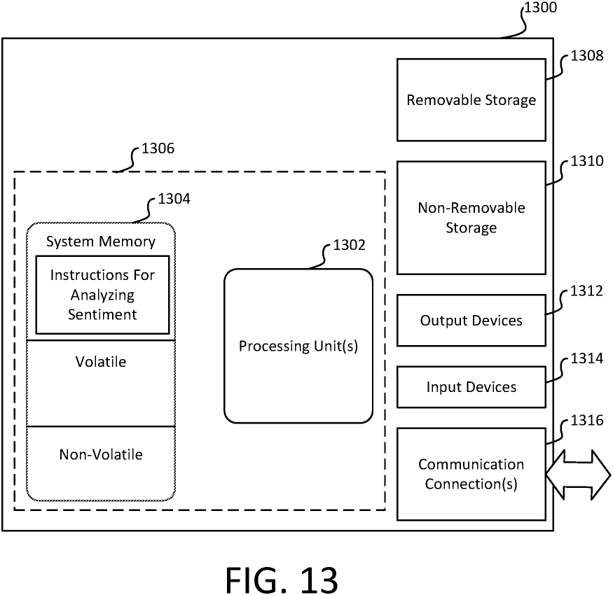

FIG. 13 illustrates a simplified block diagram of a device with which aspects of the present disclosure may be practiced in accordance with aspects of the present disclosure. The device may be a mobile computing device, for example. One or more of the present embodiments may be implemented in an operating environment 1000. This is only one example of a suitable operating environment and is not intended to suggest any limitation as to the scope of use or functionality. Other well-known computing systems, environments, and/or configurations that may be suitable for use include, but are not limited to, personal computers, server computers, handheld or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1300 typically includes at least one processing unit 1302 and memory 1304. Depending on the exact configuration and type of computing device, memory 1304 (instructions for analyzing sentiment as described herein) may be volatile (such as RAM), non-volatile (such as ROM, flash memory, etc.), or some combination of the two. This most basic configuration is illustrated in FIG. 13 by dashed line 1306. Further, the operating environment 1300 may also include storage devices (removable, 1008, and/or non-removable, 1310) including, but not limited to, magnetic or optical disks or tape. Similarly, the operating environment 1300 may also have input device(s) 1314 such as remote controller, keyboard, mouse, pen, voice input, on-board sensors, etc. and/or output device(s) 1312 such as a display, speakers, printer, motors, etc. Also included in the environment may be one or more communication connections, 1316, such as LAN, WAN, a near-field communications network, a cellular broadband network, point to point, etc.

Operating environment 1300 typically includes at least some form of computer readable media. Computer readable media can be any available media that can be accessed by processing unit 1302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1300 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for generating sentiment assocaitd with a call according to at least the examples provided in the sections below. A computer-implemented method comprises receiving an utterance associated with the call, the call including one or more utterances, a utterance including one or more sentences, and a sentence including one or more words; generating, for a set of sentences in the utterance, one or more sentence sentiments, the one or more sentence sentiments representing sentiment associated with one or more individual sentences in the set of sentences; generating, based on the one or more sentence sentiments, an utterance sentiment, the utterance sentiment representing sentiment associated with the utterance; generating, based upon the utterance sentiment, a call sentiment, the call sentiment representing sentiment associated with the call; and providing the call sentiment. The method further comprises generating a sentiment momentum associated with the call, the sentiment momentum indicating a sentiment trend during the call, the sentiment trend indicating a fluctuation of sentiment across two or more parts of the call. The method further comprises generating, based on utterance sentiment associated with utterances made by a participant to the call, speaker sentiment for the participant. The method further comprises training a prediction model using training data, wherein the training data includes paired training sentence and sentiment classification, and wherein the sentiment classification is one of positivity, neutrality, or negativity; and wherein the one or more sentence sentiments are generated using the prediction model. The utterance sentiment includes one or more numerical values indicating sentiment. The method further comprises aggregating, based on a predefined set of rules, utterance sentiment associated with the one or more utterances; and the call sentiment is generated based upon the aggregated utterance sentiment. The predefined set of rules comprises weighing utterance sentiment associated with a last utterance of the call to have a greater effect on the call sentiment than other utterance sentiments associated with other utterances. The method further comprises receiving call data, wherein the call data comprises a transcript of the call; separating the call data into one or more sentences; storing individual sentence sentiments for the one or more sentences; grouping the one or more sentences into one or more utterances; storing individual utterance sentiments for the one or more utterances; and storing the call sentiment. The method further comprises obtaining a selection of part of the call data in response to a query; and providing a sentiment for a part of the call data, wherein the part of the call data is identified based upon the query. The method further comprises analyzing call data while the call is in progress; determining a current sentiment momentum associated with the ongoing call; and providing a notification based upon the current sentiment momentum. The method further comprises receiving a search request for a particular sentiment; identifying, based on the search request, one or more utterances associated with the particular sentiment; generating, based on the obtained one or more utterances, an exemplary conversation; and providing the exemplary conversation.

Another aspect of the technology relates to a system. The system comprises a processor; and a memory storing computer-executable instructions that when executed by the processor cause the system to: receiving an utterance associated with a call, the call including one or more utterances, a utterance including one or more sentences, and a sentence including one or more words; generating, for a set of sentences in the utterance, one or more sentence sentiments, the one or more sentence sentiments representing sentiment associated with one or more individual sentences in the set of sentences; generating, based on the one or more sentence sentiments, an utterance sentiment, the utterance sentiment representing sentiment associated with the utterance; generating, based upon the utterance sentiment, a call sentiment, the call sentiment representing sentiment associated with the call; and providing the call sentiment. Execution of the computer-executable instructions further causing the system to generate a sentiment momentum associated with the call, the sentiment momentum indicating a sentiment trend during the call, the sentiment trend indicating a fluctuation of utterance sentiment across two or more utterances made during the call. Execution of the computer-executable instructions further causing the system to generate, based on utterance sentiment associated with utterances made by a participant to the call, speaker sentiment for the participant as sentiment saturation associated with the call. Eexecution of the computer-executable instructions further causing the system to training a prediction model using training data, wherein the training data includes paired training sentence and sentiment classification, and wherein the sentiment classification is one of: positivity, neutrality, or negativity; and wherein the one or more sentence sentiments are generated using the prediction model. The utterance sentiment includes one or more numerical values indicating sentiment.

In still further aspects, the technology relates to a computer-implemented method. The method comprises receiving call data, wherein a call data comprises a transcript of the call; separating the call data into one or more sentences; determining, based on the one or more sentences, one or more individual sentence sentiments for the one or more sentences; storing the one or more individual sentence sentiments; grouping the one or more sentences into one or more utterances; determining, based on the one or more utterances, one or more individual utterance sentiments for the one or more utterances; storing the one or more utterance sentiments; determining, based on the one or more utterance sentiments, a call sentiment associated with the call; and storing the call sentiment. The method further comprises obtaining a selection of part of the call data in response to a query; and providing a sentiment for a part of the call data, wherein the part of the call data is identified based upon the query. The method further comprises analyzing call data while the call is in progress; determining a current sentiment momentum associated with the ongoing call; and providing a notification based upon the current sentiment momentum. The method further comprises receiving a search request for a particular sentiment; identifying, based on the search request, one or more utterances associated with the particular sentiment; generating, based on the obtained one or more utterances, an exemplary conversation; and providing the exemplary conversation.

Any of the one or more above aspects in combination with any other of the one or more aspect. Any of the one or more aspects as described herein.

What is claimed is:

1. A computer-implemented method for generating sentiment associated with a call, the method comprising:
receiving an utterance associated with the call, the call including one or more utterances, a utterance including one or more sentences, and a sentence including one or more words;
generating, for a set of sentences in the utterance, one or more sentence sentiments, the one or more sentence sentiments representing sentiment associated with one or more individual sentences in the set of sentences;
generating, based on the one or more sentence sentiments, an utterance sentiment, the utterance sentiment representing sentiment associated with the utterance;
generating, based upon the utterance sentiment, a call sentiment, the call sentiment representing sentiment associated with the call; and
providing the call sentiment.

2. The computer-implemented method according to claim 1, wherein the method further comprises:
generating a sentiment momentum associated with the call, the sentiment momentum indicating a sentiment trend during the call, the sentiment trend indicating a fluctuation of sentiment across two or more parts of the call.

3. The computer-implemented method according to claim 1, wherein the method further comprises:
generating, based on utterance sentiment associated with utterances made by a participant to the call, speaker sentiment for the participant.

4. The computer-implemented method according to claim 1, wherein the method further comprises:
training a prediction model using training data, wherein the training data includes paired training sentence and sentiment classification, and wherein the sentiment classification is one of positivity, neutrality, or negativity; and
wherein the one or more sentence sentiments are generated using the prediction model.

5. The computer-implemented method according to claim 1, wherein the utterance sentiment includes one or more numerical values indicating sentiment.

6. The computer-implemented method according to claim 1, wherein the method further comprises:
aggregating, based on a predefined set of rules, utterance sentiment associated with the one or more utterances; and
the call sentiment is generated based upon the aggregated utterance sentiment.

7. The computer-implemented method according to claim 6, wherein the predefined set of rules comprises weighing utterance sentiment associated with a last utterance of the call to have a greater effect on the call sentiment than other utterance sentiments associated with other utterances.

8. The computer-implemented method according to claim 1, wherein the method further comprises:
receiving call data, wherein the call data comprises a transcript of the call;
separating the call data into one or more sentences;
storing individual sentence sentiments for the one or more sentences;
grouping the one or more sentences into one or more utterances;
storing individual utterance sentiments for the one or more utterances; and
storing the call sentiment.

9. The computer-implemented method according to claim 8, where the method further comprises:
obtaining a selection of part of the call data in response to a query; and
providing a sentiment for a part of the call data, wherein the part of the call data is identified based upon the query.

10. The computer-implemented method according to claim 1, wherein the method further comprises:
analyzing call data while the call is in progress;
determining a current sentiment momentum associated with the ongoing call; and
providing a notification based upon the current sentiment momentum.

11. The computer-implemented method according to claim 8, the method further comprising:
receiving a search request for a particular sentiment;
identifying, based on the search request, one or more utterances associated with the particular sentiment;
generating, based on the obtained one or more utterances, an exemplary conversation; and
providing the exemplary conversation.

12. A system, comprising:
a processor; and
a memory storing computer-executable instructions that when executed by the processor cause the system to:
receiving an utterance associated with a call, the call including one or more utterances, a utterance including one or more sentences, and a sentence including one or more words;
generating, for a set of sentences in the utterance, one or more sentence sentiments, the one or more sentence sentiments representing sentiment associated with one or more individual sentences in the set of sentences;
generating, based on the one or more sentence sentiments, an utterance sentiment, the utterance sentiment representing sentiment associated with the utterance;
generating, based upon the utterance sentiment, a call sentiment, the call sentiment representing sentiment associated with the call; and
providing the call sentiment.

13. The system according to claim 12, wherein execution of the computer-executable instructions further causing the system to:
generate a sentiment momentum associated with the call, the sentiment momentum indicating a sentiment trend during the call, the sentiment trend indicating a fluctuation of utterance sentiment across two or more utterances made during the call.

14. The system according to claim 12, wherein execution of the computer-executable instructions further causing the system to:
generate, based on utterance sentiment associated with utterances made by a participant to the call, speaker sentiment for the participant as sentiment saturation associated with the call.

15. The system according to claim 12, wherein execution of the computer-executable instructions further causing the system to:
training a prediction model using training data, wherein the training data includes paired training sentence and sentiment classification, and wherein the sentiment classification is one of: positivity, neutrality, or negativity; and
wherein the one or more sentence sentiments are generated using the prediction model.

16. The system according to claim 12, wherein the utterance sentiment includes one or more numerical values indicating sentiment.

17. A computer-implemented method, comprising:
receiving call data, wherein a call data comprises a transcript of the call;
separating the call data into one or more sentences;
determining, based on the one or more sentences, one or more individual sentence sentiments for the one or more sentences;
storing the one or more individual sentence sentiments;
grouping the one or more sentences into one or more utterances;
determining, based on the one or more utterances, one or more individual utterance sentiments for the one or more utterances;
storing the one or more utterance sentiments;
determining, based on the one or more utterance sentiments, a call sentiment associated with the call; and
storing the call sentiment.

18. The computer-implemented method according to claim 17, wherein the method further comprises:
obtaining a selection of part of the call data in response to a query; and
providing a sentiment for a part of the call data, wherein the part of the call data is identified based upon the query.

19. The computer-implemented method according to claim 17, wherein the method further comprises:
analyzing call data while the call is in progress;
determining a current sentiment momentum associated with the ongoing call; and
providing a notification based upon the current sentiment momentum.

20. The computer-implemented method according to claim 17, the method further comprising:
receiving a search request for a particular sentiment;
identifying, based on the search request, one or more utterances associated with the particular sentiment;
generating, based on the obtained one or more utterances, an exemplary conversation; and
providing the exemplary conversation.
